(19) United States
(12) Patent Application Publication
(10) Pub. No.: US 2010/0190496 A1
(43) Pub. Date: Jul. 29, 2010

(54) METHOD TO GENERATE NEIGHBOR LIST FEMTO CELL ENVIROMENT

(75) Inventor: Gopinath Murali CHINNATHAMBI, Erode (IN)

Correspondence Address: LOWE HAUPTMAN HAM & BERNER, LLP, 1700 DIAGONAL ROAD, SUITE 300, ALEXANDRIA, VA, 22314, US

(73) Assignee: Continuous Computing Inc., San Diego, CA (US)

(21) Appl. No.: 12/358,784

(22) Filed: Jan. 23, 2009

(51) Int. Cl. H04W 4/00

(52) U.S. Cl. 455/435.1

(57) ABSTRACT

A method and system for neighbor list generation in a femtocell environment based on access permissions of user device at neighboring femto access points (FAP) is disclosed. The method of accessing a network comprises a femto gateway determining location of a user device, using the femto access points as reference, femto gateway creating a list of neighboring femto access points the user device is authorized to access, femto gateway sending the neighbor list to a femto access point, where the user device is camped on the femto access point, femto access point sending the list to the user device, user device scanning femto access points in the list and the user device requesting access to a femto access point from the list, if needed.

### FIELD OF INVENTION

The embodiments herein generally relate to cellular networks, and, more particularly, to Femtocell networks.

### BACKGROUND AND PRIOR ART

In the traditional cellular radio systems, the Radio Access Network (RAN) comprises of Base Station Controller (BSC) and a set of Base Stations (BS). Each BS in the RAN serves a certain part of geographical area. The operator configures each of the BS with the neighbor BS's information, for instance, Base Station Identity Code (BSIC), Frequency (in the case of GSM networks) and the like.

The BS communicates with a user device through an air interface. The user device periodically scans for the strongest pilot signal in the location area and then camps on the base station where it has received the strongest signal. The BS ensures continuous connectivity to the user device by transmitting neighboring BS information either through system information broadcast or through dedicated messages to the user device. The neighbor information enables the user device to periodically scan the neighboring BS's signal strength. If the user device moves towards the coverage area of the neighbor BS, there is a possibility that the signal strength of the currently selected BS is less than the neighbor base station's signal strength. If the neighboring base station signal is stronger than the serving base station, the user device performs handover to receive better connectivity.

To improve the coverage of cellular networks, Femto Access Points (FAPs) are deployed in the user location. FAPs are small base stations which are placed in the end users' home/office to improve coverage for the end users. BS is controlled by the network operators, whereas FAPs may be controlled by the end users. The end users can move FAPs from one location to another.

The deployment of FAPs requires the operator to configure each FAP with the list of authorized users permitted to make use of its coverage. To enable neighbor measurements for each authorized user device at FAP, the operator has to configure the neighbor list for each user device at the FAP. So even if the operator configures the FAP with the neighbor list information based on location for each user device, access to a neighboring FAP is restricted only to authorized users. If the unauthorized user device tries to connect to a neighboring FAP with a stronger signal, the neighboring FAP rejects the call as the user device is not authorized to access it. The user device sends measurement reports to FAP periodically or whenever the serving signal quality is less than the configured threshold. The transmission of measurement reports for unauthorized neighboring FAPs would impose a unnecessary signaling overhead. Also the frequent measurement of signal quality from unauthorized neighboring FAPs leads to wastage of user device battery power.

### SUMMARY OF INVENTION

In view of the foregoing, an embodiment herein provides a method of accessing a network, the network comprising of a plurality of user devices, a plurality of femto access points and at least one femto gateway is disclosed. The method comprises of the femto gateway determining location of a user device, using the femto access points as reference, femto gateway creating a list of neighboring femto access points the user device is authorized to access, femto gateway sending the list to a first femto access point, where the user device is camped on the first femto access point, first femto access point sending the list to the user device, the user device scanning femto access points present in the list, and the user device requesting access to a second femto access point from the list, if signal strength of the second femto access point present in the list is greater than the signal strength of the first femto access point. The information in the femto gateway comprises identity of each femto access point, list of user devices authorized to access each femto access point and authorized neighbor list information for each user device at each femto access point. The neighbor list is updated by the femto gateway dynamically. The femto gateway sends the list to each femto access points after a determined period or when changes occur in the list. The changes can be determined by the femto gateway through re-registration of femto access point or through the loss of existing connectivity between femto access point and femto gateway. The femto gateway updates each femto access point with authorized neighbor list for each authorized user device. The femto access point forwards the neighbor list to each connected user device.

Embodiments herein further disclose a femto gateway, where the femto gateway is connected to a plurality of femto access points and a cellular network. The femto gateway comprises at least one means adapted for determining location of a user device, using the femto access points as reference, creating a list of neighboring femto access points the user device is authorized to access, sending the list to a first femto access point, where the user device is camped on the first femto access point. The femto gateway is adapted to maintain a database comprising identity of each femto access point, list of the user devices authorized to access each femto access point and the neighbor list information for user devices at femto access points.

Embodiments herein further disclose a femto access point where the femto access point is connected to a femto gateway. The femto access point comprising at least one means adapted for receiving a list of authorized neighbor femto access points a user device is permitted to connect to from the femto gateway, wherein the user device is camped on the femto access point and sending the list to the user device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

The embodiments herein will be better understood from the following description with reference to the drawings, in which:

FIG. 1 depicts a network block diagram of a femto network, according to embodiments disclosed herein;

FIG. 2 depicts a block diagram of a femto gateway, according to embodiments disclosed herein;

FIG. 3 depicts a block diagram of a femto access point (FAP), according to embodiments disclosed herein;

FIG. 4 is a schematic diagram depicting a user device connected to a cellular network using femto access points, according to embodiments disclosed herein;

FIG. 5 depicts a schematic diagram illustrating the call flow for generating a neighbor list by a femto gateway, according to the embodiments disclosed herein;

FIG. 6 is a flow chart illustrating a method of providing neighbor list to a user device, according to the embodiments disclosed herein;

FIG. 7 is a schematic diagram depicting a femto access point neighbor list updation of a user device connected to a cellular network, according to embodiments disclosed herein;

FIG. 8 depicts a schematic diagram illustrating the call flow for updating femto access point neighbor list, according to embodiments disclosed herein; and

FIG. 9 depicts a flow chart illustrating a method of updating neighbor list based on user device location, according to the embodiments herein.

### DESCRIPTION OF EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

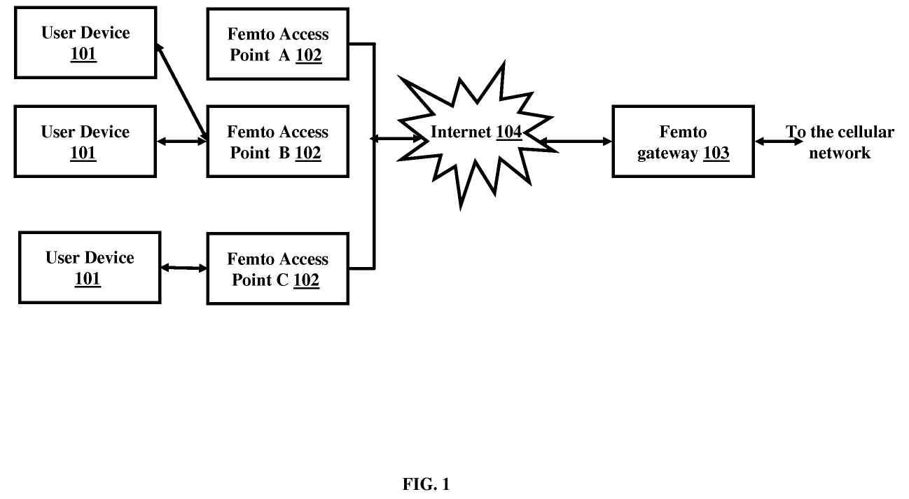

The embodiments herein disclose a method and system for neighbor list generation in a femtocell environment based on access permissions of a user device at neighboring Femto Access Points (FAP). Referring now to the drawings, and more particularly to FIGS. 1 through 9, where similar reference characters denote corresponding features consistently throughout the figures, there are shown preferred embodiments.

Embodiments herein disclose a femto gateway, which is connected to a cellular network and a plurality of femto access points, determining the location of a user device, where the user device is a communication device capable of communicating using at least a cellular network. The femto gateway further determines the authorized FAPs of the user device and creates a list of authorized neighboring FAP for the user device, where the authorized neighboring FAP is a FAP the user device is permitted to connect to. The femto gateway sends the list to the user device through the FAP on which the user device is currently camped. The user device measures the signal strength of all the FAPs in the received list. If the signal strength of a FAP in that list is higher than the current signal strength received from the current FAP, then the user device makes a request for a handover to the neighboring FAP with the strongest signal.

FIG. 1 depicts a network block diagram of a femto network, according to embodiments herein. The femto network, as depicted comprises of a plurality of user devices 101, a plurality of FAPs 102 which are connected through the internet 104 to a femto gateway 103 and the femto gateway is further connected to the cellular network. The users through the user device 101 connect to the cellular network through the FAPs 102 and the femto gateways 103. The user device 101 is connected to an authorized FAP 102 and more than one user device 101 may be connected to a single FAP 102, as depicted in FIG. 1. The FAP 102 is a low power cellular base station incorporating all the functionality of a typical cellular base station, which connects to the cellular network using an internet connection 104. Data sent by the user device 101 or to be received by the user device 101 are sent or received through the internet connection 104 to or from the cellular network. The femto gateway 103 integrates the plurality of FAPs into the cellular network by managing traffic received from the plurality of FAPs 102 and splitting the voice and data traffic flows into appropriate sections of the cellular network. The femto gateway 103 monitors each FAP 102 connection for intrusions and attacks, Unauthorized FAP connections are identified and discarded by the femto gateway 103.

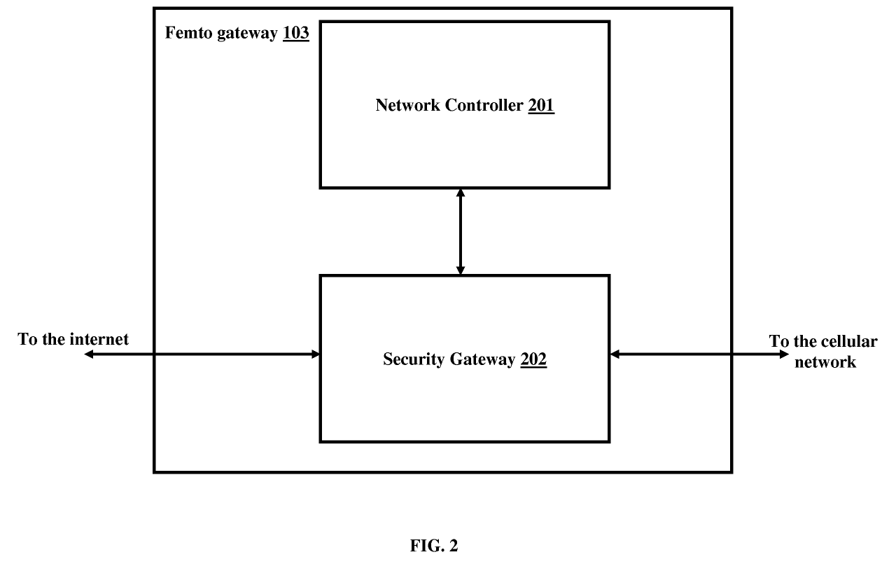

FIG. 2 depicts a block diagram of a femto gateway, according to embodiments as disclosed herein. A femto gateway 103 comprises of at least a network controller 201 and a security gateway 202. As the femto network uses the internet for communication, the probability of an attack through the internet is very high. The security gateway 201 acts as a shield for the cellular network. The security gateway 202 monitors each FAP connection for intrusions. Unauthorized FAP connections are identified and discarded by the security gateway. The network controller 201 manages the flow of packets to and from the cellular network. The network controller 201 also manages sessions between the user devices 101 and the cellular network. The network controller 201 also performs coordination between the plurality of FAPs connected to the femto gateway 103. The network controller 201 determines the location of a user device 101 connected to the femto network and creates a list of authorized neighboring FAPs 102 for the user device 101. The network controller 201 sends the list to the FAP 102, on which the mobile device is camped, which further sends the list to the user device 101.

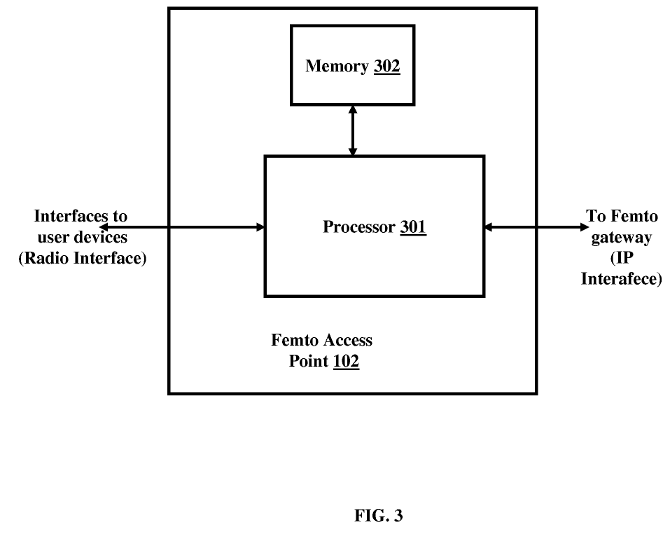

FIG. 3 depicts a block diagram of a femto access point (FAP), according to embodiments disclosed herein. A FAP 102 comprises of a processor 301 and a memory 302. The processor 301 performs radio interface protocol related functions as well as IP protocol functions. The processor 301 applies the FAP configuration as determined by the operator of the cellular network. The processor 301 receives or sends the messages from or to the user devices 101 through a radio interface and interacts with the femto gateway 103 through secure connection using an IP interface. The memory 302 comprises of a FAP configuration, which further comprises of the list of user devices that are authorized to access the FAP. The list of user devices contains the identity of each user device such as International Mobile Subscriber Identity (IMSI)/Electronic Serial Number (ESN)/International Mobile Equipment Identity (IMEI) or any other user device specific identity determined by the radio technology. The list of authorized neighboring FAPs 102 as generated by the femto gateway 103 for a user device 101 is received by the processor through the IP interface and forwarded to the user device using the radio interface. When a FAP 102 receives a request from a user device 101 for a connection, the processor 301 verifies if the user device 101 has authorization to connect to this FAP 102. If the user device 101 is authorized to connect to this FAP 102, the FAP 102 then forwards the message to the femto gateway 103 for further verification.

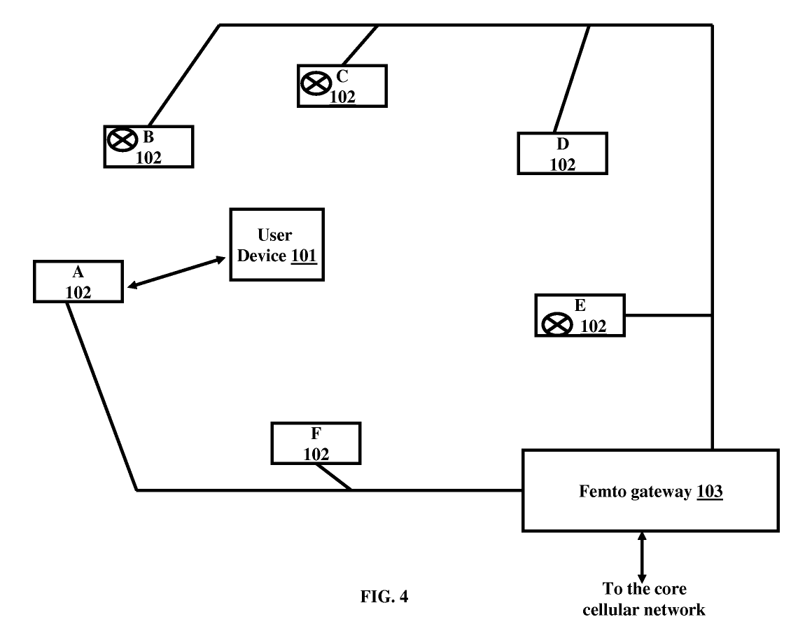

FIG. 4 depicts a user device connected to a cellular network using femto access points, according to embodiments disclosed herein. A femto gateway 103 is connected to a cellular network and a plurality of femto access points, determining the location of a user device 101. The femto gateway 103 integrates the plurality of FAPs 102 into the cellular network by managing traffic received from the plurality of FAPs 102 and splitting the voice and data traffic flows into appropriate sections of the cellular network. The femto gateway 103 determines the authorized neighboring FAPs 102 of the user device 101 and creates a list of authorized neighboring FAP for the user device. The authorized neighboring FAP is a neighboring FAP 102 the user device 101 is permitted to connect to. The femto gateway 103 sends the list to the user device 101 through the FAP 102 on which the user device 101 is currently camped. The femto gateway 103 sends neighbor list to each femto access point where user device has camped 102 after a specified period or when changes occur in the list. The changes in the list can be determined by the femto gateway through re-registration of a femto access point 102 with the femto gateway 103 or through the loss of existing connectivity between a femto access point 102 and femto gateway 103. The user device 101 is given access only to femto access points A, D and F 102. The user device 101 is given the list of authorized neighboring femto access point based on user device 101 access permission on neighboring femto access points and also based on user device location with respect to the current camped on femto access point.

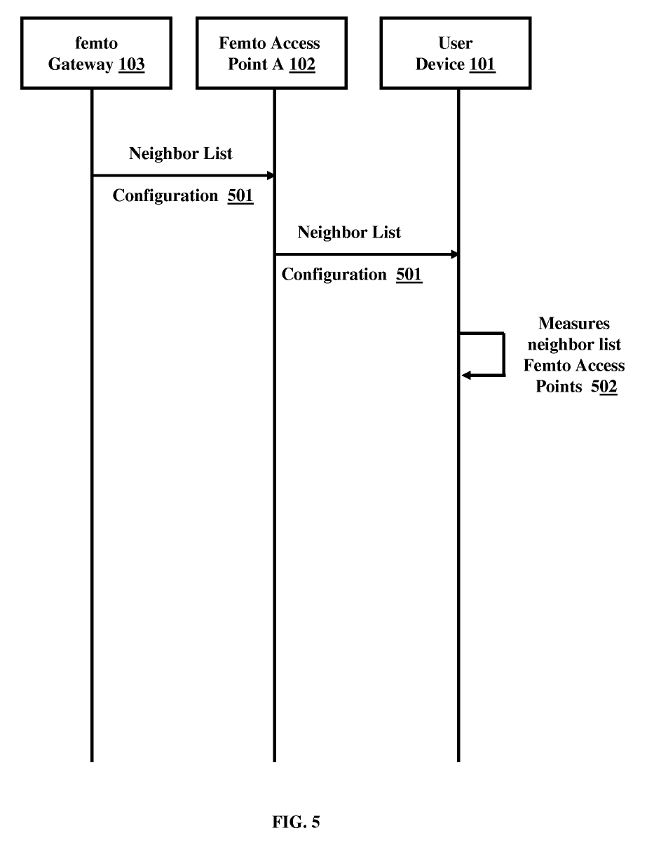

FIG. 5 depicts a schematic diagram illustrating the call flow for generating neighbor list by a femto gateway, according to the embodiments disclosed herein. The femto gateway 103 determines the location of the user device 101. Based on the user device 101 location, the femto gateway 102 creates a list of authorized neighboring FAPs, known as the neighbor list configuration 501. The femto gateway 103 sends the neighbor list configuration 501 to FAPs 102. The FAP 102 forwards the neighbor list configuration 501 to the user device 101. The femto gateway 103 sends neighbor list to each femto access point 102 after a specified period or when changes occur in the list. The user device 101 measures the signal strength received from FAPs 102 in the neighbor list. If the user device 101 finds that the signal strength of the current FAP is greater than the other FAPs in the neighbor list, no further action is taken by the user device 101

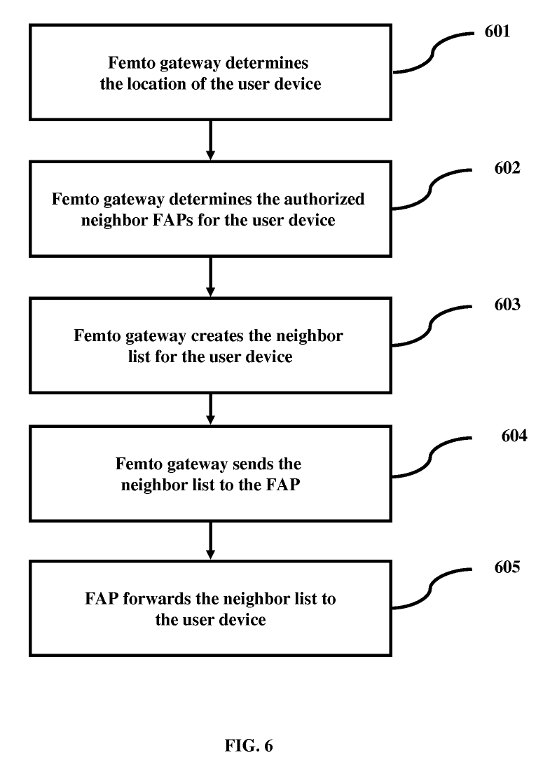

FIG. 6 is a flow chart illustrating a method of providing neighbor list to a user device, according to the embodiments disclosed herein. The femto gateway 103 determines (601) the location of the user device 101. The femto gateway 103 then determines (602) the neighboring FAPs 102 authorized for the user device 101. Further, femto gateway 103 creates (603) the neighbor list of authorized FAPs for the user device 101. Thereafter, the femto gateway 103 sends (604) the neighbor list to the femto access points (FAP) 102. The femto gateway 103 sends neighbor list to each femto access point 102 after a specified period or when changes occur in the list. The FAP then forwards (605) the neighbor list to the user device 101, wherein the user device 101 measures the strength of signal received from the FAPs 102 present in the neighbor list. The various actions in method 600 may be performed in the order presented, in a different order or simultaneously. Further, in some embodiments, some actions listed in FIG. 6 may be omitted.

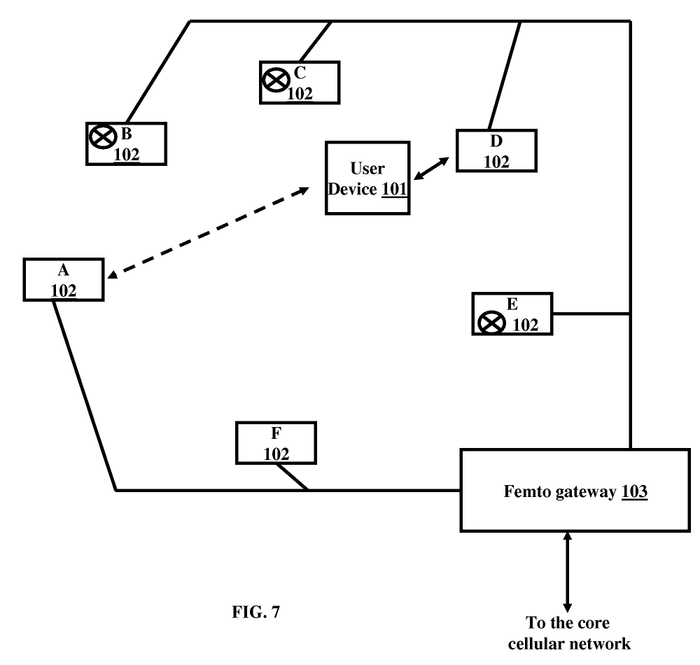

FIG. 7 depicts a femto access point neighbor list update for a user device connected to a cellular network, according to embodiments disclosed herein. A femto gateway 103 is connected to a cellular network and a plurality of FAPs 102, determining the location of a user device 101, where the user device 101 is any device capable of communicating using a cellular network. The femto gateway 103 integrates the plurality of FAPs 102 into the cellular network by managing traffic received from the plurality of FAPs 102 and splitting the voice and data traffic flows into appropriate sections of the cellular network. The femto gateway 103 determines the authorized neighboring FAPs 102 of the user device 101 and creates a list of authorized neighboring FAPs 102. The authorized neighboring FAP is a neighboring FAP 102 the user device 101 is permitted to connect to. The femto gateway 103 sends the list to the user device 101 through the FAP 102 on which the user device 101 is currently camped. The femto gateway 103 sends neighbor list to each femto access point 102 after a specified period or when changes occur in the list. In the user device 101 location depicted in FIG. 7, FAP-D 102 is the only authorized neighboring FAP 102 for the user device 101. The FAP 102 then forwards the neighbor list to the user device 101, wherein the user device 101 measures the strength of the signals received from the FAPs 102 in the neighbor list. When the camped user device 101 shifts from one location to another, the signal strength of the currently selected FAP can be less than the signal strength of another FAP 102 present in the neighbor list. The user device 101 can then switch the connection from the serving FAP 102 to the FAP 102 in the neighbor list with higher signal strength. The neighbor list information is critical in maintaining the connectivity of user device 101 as the information is used to determine and execute hand offs for the user device 101.

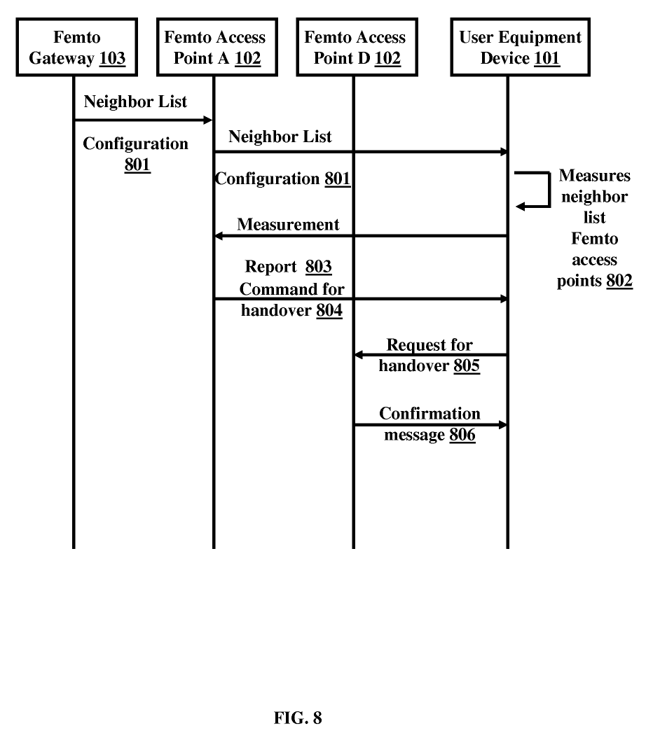

FIG. 8 depicts a schematic diagram illustrating the call flow for updating femto access point neighbor list, according to embodiments disclosed herein. The femto gateway 103 determines the location of the user device 101. Based on the user device 101 location, the femto gateway 102 creates an authorized FAP neighbor list configuration 801. The femto gateway sends the neighbor list configuration 801 to FAPs 102 on which the user device 101 is camped. The FAP 102 forwards the neighbor list configuration 801 to the user device 101, which measures the signal strength of the FAPs 102 present in the list. The user device 101 then sends the measurement report 803 stating that FAP-D 102 has higher signal strength as compared to FAP-A 102 on which the user device 101 is camped. The FAP-A 102 then sends a message for handover to FAP-D 804 to the user device 101. The user device 101 then sends a message requesting for handover 805 to FAP-D 102. The FAP-D 102 approves the request and sends a confirmation 806 to the user device.

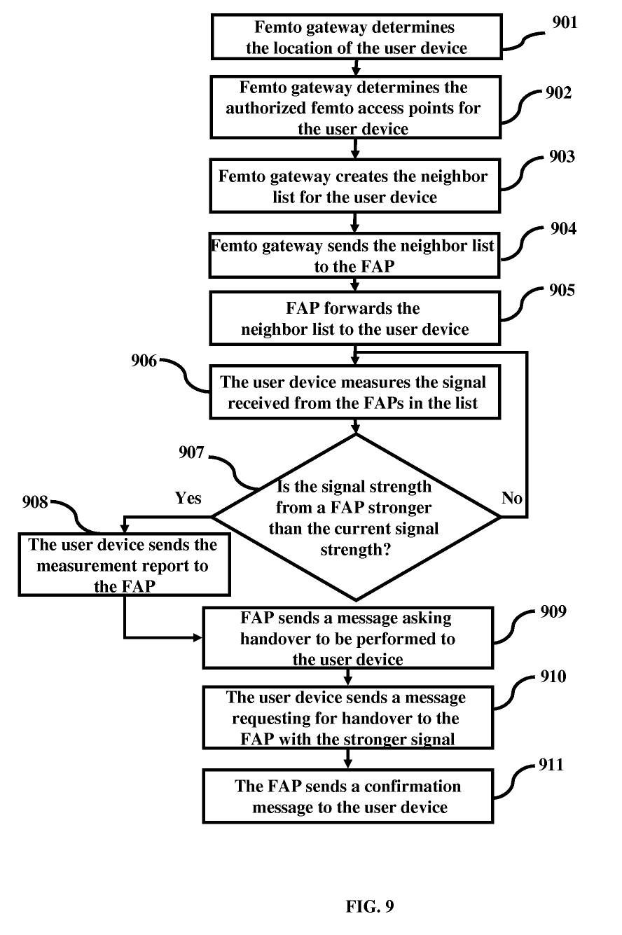

FIG. 9 depicts a flow chart illustrating a method of updating neighbor list based on user device location, according to the embodiments herein. The femto gateway 103 determines (901) location of the user device 101. Femto gateway 103 then determines (902) the authorized neighboring FAPs 102 for the user device 101. Further femto gateway 103 creates (903) the neighbor list for the user device 101 and sends (904) the neighbor list to the FAPs 102. The femto gateway 103 sends the neighbor list to each FAP 102 where the user device is camped after a specified period or when changes occur in the list. The changes can be determined by the femto gateway through re-registration of a FAP 102 with the femto gateway 103 or through the loss of existing connectivity between a FAP 102 and a femto gateway 103. The FAP 102 forwards (905) the neighbor list to the user device 101. The user device 101 measures (906) the signal strength received from the FAPs 102 in the neighbor list. The user device 101 then performs a check (907) to find if the signal strength of the signal received from any of the FAPs 102 in the neighbor list is stronger than the signal strength received from the current FAP 102. If the strength of the signal received from any of the FAPs 102 in the neighbor list is stronger than the signal strength received from the current FAP 102, then the user device 101 sends (908) the measurement report to the current FAP 102. The current FAP 102 then sends (909) a message for handover to the FAP 102 with the stronger signal to the user device 101 and the user device 101 sends (910) a message requesting for handover to the FAP 102 with the stronger signal. The FAP 102 with the stronger signal approves the request and sends (911) a confirmation message to the user device. The various actions in method 900 may be performed in the order presented, in a different order or simultaneously. Further, in some embodiments, some actions listed in FIG. 9 may be omitted.

In embodiments disclosed herein, the femto gateway configures the authorized neighbor list dynamically without intervention from the operator, thereby reducing errors in the neighbor list configuration. Further, the embodiment reduces battery power consumption in user device, as user device does not measure the signal strength of all neighboring FAPs. The user device scans only the authorized FAPs mentioned in the neighbor list and hence unnecessary signaling is reduced at the target FAPs and in the user devices.

In the embodiment disclosed herein, the femto gateway updates each user device dynamically with the authorized neighbor information based on user device's access restrictions and location of user device. Further, the femto gateway maintains a database of IMSI or ESN or any other UE identity, FAP hardware identity, authorized neighbor list information for each connected user device and the like.

The embodiment disclosed herein helps in enabling effective neighbor list search procedure with the list of authorized neighboring FAPs and also in increasing the successful handover rates as well as reducing unnecessary signaling load in the FAP during FAP to FAP handovers.

The embodiments disclosed herein can be implemented through at least one software program running on at least one hardware device and performing network management functions to control the network elements. The network elements shown in the figures include blocks which can be at least one of a hardware device, a software module or a combination of hardware device and software module.

It is understood that the scope of the protection is extended to such a program and in addition to a computer readable means having a message therein, such computer readable storage means contain program code means for implementation of one or more steps of the method, when the program runs on any suitable programmable device. The method is implemented in a preferred embodiment through or together with a software program written in e.g. Very high speed integrated circuit Hardware Description Language (VHDL) or C, C++, Java, or using another programming language, or implemented by one or more VHDL, C, C++, or Java processes or routines, or several software modules being executed on at least one hardware device. The hardware device can be any kind of device which can be programmed including e.g. any kind of computer like a server or a personal computer, an FPGA, a processor, or the like, or any combination thereof, e.g. one processor and two FPGAs. The device may also include means which could be e.g. hardware means like e.g. an ASIC, or a combination of hardware and software means, e.g. an ASIC and an FPGA, or at least one microprocessor and at least one memory with software modules located therein. Thus, the means are at least one hardware means and/or at least one software means. The method embodiments described herein could be implemented in pure hardware or partly in hardware and partly in software. The device may also include only software means. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended

What is claimed is:

1. A method of accessing a network, said network comprising of a plurality of user devices, a plurality of femto access points and at least one femto gateway, said method comprising steps of
said femto gateway determining location of a user device, using said femto access points as reference;
said femto gateway creating a list of neighboring femto access points said user device is authorized to access;
said femto gateway sending said list to a first femto access point, where said user device is camped on said first femto access point;
said first femto access point sending said list to said user device;
said user device scanning femto access points present in said list; and
said user device requesting access to a second femto access point from said list, if signal strength of said second femto access point present in said list is greater than the signal strength of said first femto access point.

2. The method, as claimed in claim 1, wherein information in said femto gateway comprises of at least one of
identity of said each femto access point;
list of user devices authorized to access said each femto access point; and
neighbor list information for said each user device at said each femto access point.

3. The method, as claimed in claim 1, wherein said list is updated by said femto gateway dynamically.

4. The method, as claimed in claim 1, wherein said femto gateway sends said list to said each femto access points after a pre-determined period.

5. The method, as claimed in claim 1, wherein said femto gateway sends said list to said each femto access points when changes occur in said list.

6. A femto gateway, wherein said femto gateway is connected to a plurality of femto access points and a cellular network, said femto gateway comprising at least one means adapted for:
determining location of a user device, using said femto access points as reference;
creating a list of neighboring femto access points said user device is authorized to access; and
sending said list to a first femto access point, where said user device is camped on said first femto access point.

7. The femto gateway, as claimed in claim 6, wherein said femto gateway is adapted to maintain a database comprising of at least one of
identity of said each femto access point;
list of said user devices authorized to access said each femto access point; and
neighbor list information for said each user device at said each femto access point.

8. A femto access point, wherein said femto access point is connected to a femto gateway, said femto access point comprising at least one means adapted for
receiving a list of authorized femto access points a user device is authorized to connect to, from said femto gateway, wherein said user device is camped on said femto access point;
sending said list to said user device.
